(19) United States
(12) Patent Application Publication
(10) Pub. No.: US 2003/0155161 A1
(43) Pub. Date: Aug. 21, 2003

(54) Integrated wheel bearing and motor

(75) Inventors: Ronald L. Dorski, Castalia, OH (US); Steven F. Baker, Bellevue, OH (US)

Correspondence Address: DELPHI TECHNOLOGIES, INC., Legal Staff, Mail Code: 482-204-450, 1450 W. Long Lake, P.O. BOX 5052, Troy, MI, 48098, US

(73) Assignee: DELPHI TECHNOLOGIES INC.

(21) Appl. No.: 10/080,251

(22) Filed: Feb. 20, 2002

(51) Int. Cl. B60K 1/00

(52) U.S. Cl. 180/65.5

(57) ABSTRACT

A wheel bearing assembly for a motor vehicle comprises a motor having a shaft and a spindle integral with the shaft. At least one row of bearing balls supports the shaft.

### TECHNICAL FIELD OF THE INVENTION

This invention relates to wheel bearings for motor vehicles.

### BACKGROUND OF THE INVENTION

U.S. Pat. No. 4,179,167 shows a common wheel bearing design that combines wheel mount, suspension mount and bearing races into a unitized package. In this design, there is a non-driven, trailing bearing, with an inner, wheel mounting spindle and a coaxial outer, suspension-mounted hub. Because the spindle is non-driven, it does not need to be attached to anything but the wheel, and it is basically just a short, solid shaft with a stub end that extends through the hub. Two rows of bearing balls running on angular contact pathways support the spindle within the hub. In order to maximize the ball count in the axially innermost ball row, a separable race piece incorporating the inner ball pathway is inserted over the stub end of the spindle and against the inner ball row after the inner ball row has been installed. The separable race piece is axially adjacent to a groove machined into the spindle stub end. A keeper ring of the proper width to maintain preload on the race piece is wedged radially into the groove, in abutment with the race piece. Then, a swage ring is roll-formed around the outside of the keeper ring to hold it into the groove. When a bearing of this type is used in a vehicle with an ABS system, the typical arrangement is to simply press fit a toothed ring over the swage ring, and install a magnetic sensor through the seal end cap, to give a completely sealed device. Such a design is shown in FIG. 9 of U.S. Pat. No. 4,978,234.

It is also known to use the same basic wheel bearing design with a driven or powered wheel. In that case, the spindle is not solid, but has a central bore that is splined to receive matching splines on a shaft that protrudes from the housing of a constant velocity joint. The shaft is bolted to the spindle. The bolting operation can also serve to set the preload in the bearing in which all the races are separable. An example of such an arrangement is disclosed in U.S. Pat. No. 5,143,458, which also shows a wheel speed sensor. The sensor assembly, including the toothed wheel called an encoder ring, are attached independently of the manner in which the wheel bearing and the constant velocity joint are assembled, in a bolt on fashion with little or no cooperation between the various structural elements.

U.S. Pat. No. 5,010,290 and U.S. Pat. No. 4,988,220 show bearings used with a powered wheel. In each design, there is more integration of components than is shown in FIG. 9 of U.S. Pat. No. 4,978,234. As disclosed, the swage ring and encoder ring are integrated into one component, serving both to hold the keeper ring against being dislodged from its groove, as well as providing the regular teeth that create a wheel speed signal.

### SUMMARY OF THE INVENTION

The present invention is a wheel bearing assembly for a motor vehicle. The wheel bearing assembly comprises a motor having a shaft and a spindle integral with the shaft. At least one row of bearing balls supports the shaft.

Accordingly, it is an object of the present invention to provide an improved wheel bearing assembly overcoming the limitations and disadvantages of the prior art.

Another object of the present invention is to provide a wheel bearing assembly of the type described above in which the motor shaft is integral with the spindle.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a cross-sectional view of an integrated wheel bearing according to the present invention for a motor vehicle; and

FIG. 2 is a cross-sectional view of an alternative embodiment of the integrated wheel bearing.

### DETAILED DESCRIPTION OF THE PRESENTLY PREFERRED EMBODIMENT

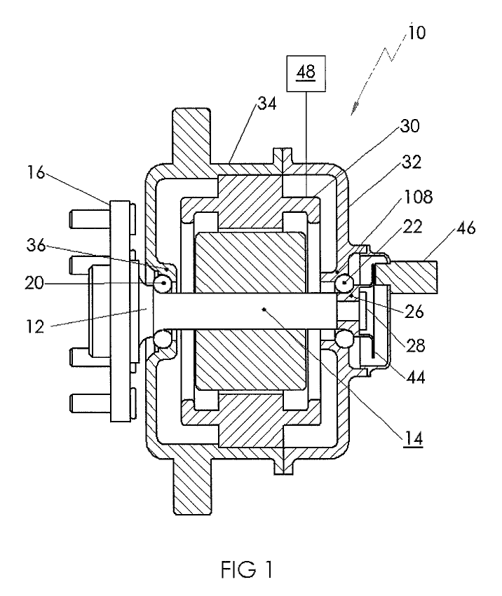

FIG. 1 shows an integrated wheel bearing and motor/generator assembly 10 according to the present invention. The assembly 10 includes a solid steel inner spindle 12 having a shaft 14 and a wheel mounting flange 16 at its outer end. An outboard row 20 of angular bearing balls runs directly on the spindle 12, while an inboard row 22 of bearing balls runs on a separable ring 24. The ring 24 sits in an annular groove 26 in the shaft 14, and is retained there by a flange 28 that may be cold formed on the end of the shaft.

Windings of an electric motor 30 are situated directly about the shaft 14. The electric motor 30 is disposed in a housing 32 that may include, as is well known, one or more mounting bosses 34 for connecting the assembly 10 to suspension components of a motor vehicle. The housing 32 also includes an integral outer race 36 for the outboard bearing balls 20, and an integral outer race 38 for the inboard bearing balls 22. Appropriate seals, well known to those of ordinary skill in the art, are preferably provided proximate the outboard and inboard bearing balls 20 and 22, respectively. An encoder ring 44 and a replaceable automatic braking sensor 46 are also provided proximate the inboard bearing balls 22.

The electric motor 30 is in communication with a controller 48. The controller 48 commands an apply current to the windings of the motor 30 to apply torque to the shaft 14, which drives the spindle 12. An assembly 10 can be provided at each of the front wheels of the motor vehicle, or at each of the rear wheels, or at all four wheels as may be desirable. It should also be appreciated that rather than a motor, the component 30 may be a generator capable of capturing energy generated by rotation of the shaft 14, such as might be desirable during regenerative braking.

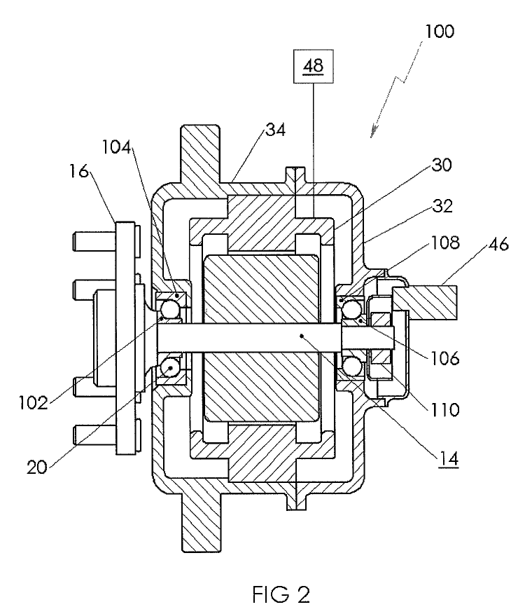

FIG. 2 shows an alternative embodiment 100 of the assembly. In the embodiment 100, the outboard bearing balls 20 are supported between a collar 102 forming an inner race and a collar 104 forming an outer race. Similarly, the inboard bearing balls 22 are supported between a collar 106 forming an inner race and a collar 108 forming an outer race. A nut 110 is threaded onto the end of the shaft 14 to retain all of the components on the shaft. The collars 102, 104, 106, and 108 are removable from the rest of the assembly. This is particularly advantageous in the event that any components of the assembly 10 require repair or replacement.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A wheel bearing assembly for a motor vehicle, the wheel bearing assembly comprising:
a motor having a shaft;
a spindle integral with the shaft; and
at least one row of bearing balls supporting the shaft.

2. The wheel bearing assembly of claim 1 further comprising a mounting flange integral with the spindle.

3. The wheel bearing assembly of claim 1 wherein the at least one row of bearing balls runs directly on the spindle.

4. The wheel bearing assembly of claim 1 wherein the at least one row of bearing balls comprises an outboard row of bearing balls and an inboard row of bearing balls.

5. The wheel bearing assembly of claim 4 wherein the outboard row of bearing balls runs directly on the spindle.

6. The wheel bearing assembly of claim 4 further comprising a ring disposed between the inboard row of bearing balls and the spindle.

7. The wheel bearing assembly of claim 6 wherein the ring is disposed in a groove in the shaft.

8. The wheel bearing assembly of claim 6 wherein the shaft comprises a flange proximate the ring.

9. The wheel bearing assembly of claim 4 wherein the outboard bearing balls are supported between a first collar and a second collar.

10. The wheel bearing assembly of claim 4 wherein the inboard bearing balls are supported between a third collar and a fourth collar.

11. The wheel bearing assembly of claim 1 wherein the motor is disposed in a housing.

12. The wheel bearing assembly of claim 11 wherein the housing includes at least one mounting boss.

13. The wheel bearing assembly of claim 11 wherein the housing includes at least one integral outer race.

14. The wheel bearing assembly of claim 1 further comprising an encoder ring proximate the shaft.

15. The wheel bearing assembly of claim 1 further comprising an automatic braking sensor proximate the shaft.

16. The wheel bearing assembly of claim 1 further comprising a controller in communication with the motor.

17. The wheel bearing assembly of claim 1 further comprising a nut threaded onto the shaft.
